(19) United States
(12) Patent Application Publication
(10) Pub. No.: US 2013/0215550 A1
(43) Pub. Date: Aug. 22, 2013

(54) ION GENERATION SYSTEM AND METHOD FOR CONTROLLING ION BALANCE

(71) Applicant: Yiqiang Sun, Beijing (CN)

(72) Inventor: Yiqiang Sun, Beijing (CN)

(73) Assignee: BEIJING GENESIS CREATIVE TECHNOLOGY LIMITED, Beijing (CN)

(21) Appl. No.: 13/883,232

(22) PCT Filed: Oct. 27, 2011
(86) PCT No.: PCT/CN11/81426

§ 371 Date: May 2, 2013

(30) Foreign Application Priority Data
Nov. 3, 2010 (CN) 201010531374.8

(51) Int. Cl. H01T 23/00

(52) U.S. Cl. CPC H01T 23/00
USPC 361/230

(57) ABSTRACT

The invention provides an ion generation system, including a high voltage pulse generator, an ion balance detector and a controller. The controller is configured to receive a signal from the ion balance detector and send a regulation signal to the high voltage pulse generator to regulate the balance of positive/negative ions of the ion generation system. The invention also provides a method for controlling the ion balance where the ion generation system is utilized. By controlling the width difference between the positive peak pulse and the negative peak pulse of a high voltage pulse or regulating the peak difference between the positive peak and the negative peak of an output pulse high voltage, the yield of positive and negative is controlled, thus balanced ions output-is achieved.

### TECHNICAL FIELD OF THE INVENTION

The invention relates to the field of ion generation, in particular to a positive/negative ion generation system and a method for controlling ion balance.

### BACKGROUND OF THE INVENTION

In common cases, gas molecules are uncharged (neutral), but some Neutral gases molecules can be ionized by irradiating, heating or discharging under a strong electric field, namely air ionization. In the air ionization process, molecules which lose electrons are positively charged, namely called positive ions, while the escaped electrons will combine with other neutral molecules to become negative ions. The ionized gases consist of positive and negative ions together with electrons and neutral species. Positive and negative ions (or electrons) can attracted and be neutralized each other to form the neutral species. Therefore, positive and negative ions are in a dynamic balance where they are continuously generated at certain conditions and disappear as they are continuously neutralized.

Air ionization technology has been applied in fields such as xerographic copier and electrostatic precipitators, and also has been widely applied for elimination of electrostatic hazards. For some materials, such as insulating materials with very high resistivity or ungrounded isolated conductive materials, static charge is quite difficult to be released once generated. Thus, Electrostatic Damage (ESD) may be caused for some electrostatic sensitive devices such as microelectronic devices. In the prior art, usually, ionized air (which includes positive and negative ions) is blown onto the surface of these charged materials, the electrostatic charges on the materials will attract opposite charges in the ionized air and to be neutralized by those ions. The charges on the surface and the electrostatic hazards caused by thereof will be eliminate rapidly. However, if charges in ionized air are unbalanced, the surface of the materials will be charged with the same polarity, as a result, the electrostatic hazards are invoked, therefore, it is necessary to control the balance of the positive and negative ions in the ionized air within a certain range. The traditional method for controlling the ion balance is that: two groups of needle electrodes are applied, one group is supplied with a positive high voltage and the other group is supplied with a negative high voltage, and the ion balance is adjusted by controlling the amplitude-difference between the positive high voltage and the negative high voltage; there is also another method in which, one group of electrodes is applied, with a positive high voltage or a negative high voltage alternatively(AC or positive/negative DC pulse high voltage), and positive and negative ions are generated periodically, ions generated by using such method are high in concentration, however the amount of ozone is also high. In order to overcome the problem of ozone generated in this method, Patent Application CN 200910004300.6 disclosed an ion generator and a method for regulating the balance of positive/negative ions by using a relatively high positive voltage with a relatively shorter positive voltage loading time and a relatively low negative voltage with a relatively longer negative voltage loading time, balanced ion output is obtained, and the unnecessary ozone generation is reduced. However, as the discharge area of needle electrodes is limited to the needle point nearby and the needle point is easy to be eroded, frequent replacement and maintenance are required. Furthermore, in conventional methods, the ion detector which monitors the balance of the positive/negative ions is not shielded (i.e. the ion detector is placed on the outside of ion generator's shell), the ions balance signal sensed by the detector is easy to be influenced by ambient electrostatic fields, and the balanced ions cannot be achieved.

Therefore, how to prepare an ion generation system which can regulate the ion balance automatically and accurately, inhibit the generation of unnecessary lower ozone generation and reduce lower the maintenance cost becomes an urgent problem to be solved in the field

### SUMMARY OF THE INVENTION

Given this situation, in order to solve the problem in the conventional arts, this invention is aimed at providing an ion generation system, this system can not only real-time monitor the balance of positive/negative ions, automatically regulate the yield of positive/negative ions, achieve the balanced output of ions, but also control the generation of unnecessary ozone, decrease the damage of electrodes and reduce the maintenance cost.

The ion generation system provided in the invention includes a high voltage pulse generator, an ion balance detector and a controller. The controller is connected between the ion balance detector and the high voltage pulse generator, and configured to output a control signal according to the ion balance signal from the ion balance detector to control the output pulse of the high voltage pulse generator.

In another implementation provided in the invention, the ion generation system further includes a DC biasing device. The biasing device is electrically connected with the controller and the high voltage pulse generator, and is configured to regulate the peak difference between the positive peak and the negative peak of an output high voltage pulse according to the control signal from-the controller.

The ion generation system provided in the invention further includes a shell, which is grounded and provided with an air inlet and an air outlet. Preferably, grounded metal nets are arranged at the air inlet and the air outlet.

Further, the ion balance detector applied in the ion generation system provided in the invention is a metal net-like ion balance detector located inside the shell.

The ion generation system provided in the invention also may be provided with a fan that is configured to quickly fan out positive and negative ions from the air outlet of the generator.

The ion generation system provided in the invention includes a discharge electrode that is a closed or open electrode formed of metal filaments. The discharge electrode is attached onto an annular insulating substrate or partially fixed on the insulating substrate via a metal connector to form a round or polygonal structure.

The diameter of the discharge electrode applied in the ion generation system provided in the invention ranges from one micrometer to ten millimeters, preferably 40-800 micrometers.

Further, the high voltage pulse generator provided in the invention includes a high voltage transformer, an oscillation circuit and a switching transistor. The oscillation circuit is connected with the base of the switching transistor, and the high voltage transformer is connected with the collector of the switching transistor. The oscillation circuit generates a pulse signal with a certain pulse width and a certain pulse period according to a signal from the controller to operate the switching transistor.

Further, the controller provided in the invention includes a proportional integral control circuit; and the employed biasing device includes two stages of inverting amplifiers.

The invention also provides a method for controlling the ion balance, including: first, the ion balance in the ion generation system is measured; the controller sends a corresponding control signal according to the ion balance status; the high voltage pulse generator regulates the peak value of the output positive pulse and negative pulse according to the control signal sent by the controller.

In another control method provided in the invention, the high voltage pulse peaks generator is further regulated and controlled by the DC biasing device, specifically the DC biasing device receives the control signal sent by the controller and generates a DC biasing overlapped on the positive/negative high voltage pulse, to regulate the peak difference of the positive peak and the negative peak of the output pulse.

The ion generation system in the invention comprises a high voltage pulse generator, an ion balance detector and a controller. The ion balance detector monitor the ion balance in the ion generation system, and the following effects of automatic regulation on the ion balance are achieved by providing a controller in the ion generation system: first, the controller regulates the peak value of the positive or negative peak of the pulse output by the high voltage pulse generator directly and automatically according to the ion balance signal from the ion balance detector; second, the DC biasing device is electrically connected with the controller and the high voltage pulse generator, according to the control signal sent by the controller, the DC biasing overlapped onto the positive pulse and negative pulse generated by the high voltage pulse generator is regulated, so that the difference between the positive peak value and the negative peak value is regulated, and the yield of the positive ions and the negative ions is controlled; third, on the premise of generating positive/negative ions in the desired concentration, the concentration of ozone is controlled as small as possible; fourth, by applying a proper electrode structure, the damage of electrodes is decreased, and the maintenance cost is reduced.

### BRIEF DESCRIPTION OF THE DRAWINGS

Drawings in the specification are provided for further understanding of the invention and form one part of the application. Exemplary embodiments of the invention and descriptions thereof are used for explaining the invention and form no improper limit for the invention. In the drawings:

FIG. 1 is a diagram of an electrode structure provided by the invention;

FIG. 2 is a diagram of another electrode structure provided in the invention;

FIG. 3a is a structure diagram of an ion generation system provided in the invention;

FIG. 3b is a side sectional-structure diagram of FIG. 3a;

FIG. 4 is a structure diagram of another ion generation system provided in the invention;

FIG. 5a is a method for controlling the ion balance provided in the invention;

FIG. 5b is another method for controlling the ion balance provided in the invention;

FIG. 6 shows an output waveform in a DC pulse mode;

FIG. 7 shows an output waveform in a positive/negative single-pulse mode;

FIG. 8 shows an output waveform in an equal-amplitude AC pulse mode;

FIG. 9 shows an output waveform in a damped-amplitude AC pulse mode;

FIG. 10 is a circuit diagram of a pulse high voltage generator in one specific implementation provided in the invention;

FIG. 11 is a circuit diagram of a controller and a biasing device in one specific implementation provided in the invention.

### DETAILED DESCRIPTION OF THE EMBODIMENTS

The purposes, technical solutions and beneficial effects of the invention will be further described in details below.

It should be appointed that, the following detailed descriptions are exemplary, aimed at providing further description for the invention. All technical and scientific terms in the text have the same meanings understood by common persons skilled in the technical field to which the invention belongs unless otherwise noted.

The ion generation system provided in the invention includes a high voltage pulse generator, an ion balance detector and a controller, the controller is configured to receive a signal sent by the ion balance detector and regulate the high voltage supply way of the high voltage pulse generator to regulate the balance of positive/negative ions.

The high voltage pulse generator can output DC pulse, positive/negative single-pulse, equal-amplitude AC pulse or damped-amplitude AC pulse according to actual demands.

The ion balance detector consists of a metal net, a high-resistance element or a capacitance element, and the metal net is grounded via the high-resistance or capacitance elements. If positive and negative charges in the system are unbalanced, a voltage signal is generated on the resistance or capacitance element, thus the ion balance detector can indicate the ion balance degree in the system. The traditional metal net-like ion balance detector is placed on the outer side of the shell, electromagnetic fields in the environment, particularly highly electrostatic fields will establish a voltage on the resistance or capacitance element, the voltage will overlap on ion balance signal and result in an error in the ions balance detecting signal, and the output ion balance of the system is damaged. In the ion generation system provided in the invention, the ion balance detector is arranged inside the ion generation system, the grounded shell shields the stray signal, and therefore the ions balance is not affected by any external interference.

The controller provided in the invention includes a power input port, a signal input port for receiving an ion balance signal from the ion balance detector, and a control signal output port, and the control signal output port is electrically connected with the high voltage pulse generator; the high voltage output port of the high voltage pulse generator is connected with the discharge electrode. The control system provided in the invention may further include a DC biasing device. The controller sends a corresponding control signal according to the signal from the ion balance detector to control the high voltage output of the high voltage pulse generator, in order to control the positive/negative peak value or pulse width of the output high voltage pulse, such control method is also called pulse height or pulse width control mode; or it outputs a corresponding control signal to the DC biasing device in order to regulate the peak difference between the positive peak and the negative peak of the output pulse high voltage, such control mode is also called biasing control mode. Through either of the above control modes, the yield of positive/negative ion and the balance of ions will be regulated to achieve the purpose of balancing the output of positive/negative ions.

The traditional electrode is a needle discharge electrode, as the discharge area is concentrated at the needle point, so the discharge electrode is easy to be damaged. Another advantage of the invention is that, the discharge electrode applied in the invention is a wire discharge electrode, and the discharge area extends to the whole electrode wire, so the damage of the electrode is reduced. The material of the electrode applied in the invention may be any metal or alloy or conductive composite material, in consideration of long-term stability, a proper discharge electrode should be selected in principles of high melting point and low sputtering yield; in consideration of cleanroom requirement, a proper discharge electrode should be selected in a principle of few participle released during the discharge. In consideration of conductivity property, in order to ensure the discharge uniform along the electrode, the total resistance of the electrode wire should be lower than 100K ohm.

The cross-sectional shape of the electrode may be round, elliptic, square (rectangular), star or any other shapes, and different shapes will influence the yield of ions. Round (elliptic) metal wire is preferred as it is easy to manufacture, while it is easier to prepare the square (rectangular) metal wire by methods such as photolithography. The diameter of the electrode ranges from 1 micrometer to 10 millimeters; the larger the diameter is, the higher the driving voltage is required, which causes a larger driving transformer and higher cost. The electrode is easy to break if it is too small, which is not good for the assembly and long-term reliable working of the electrode. Comprehensively, an electrode with a diameter of 40-800 micrometers is preferred.

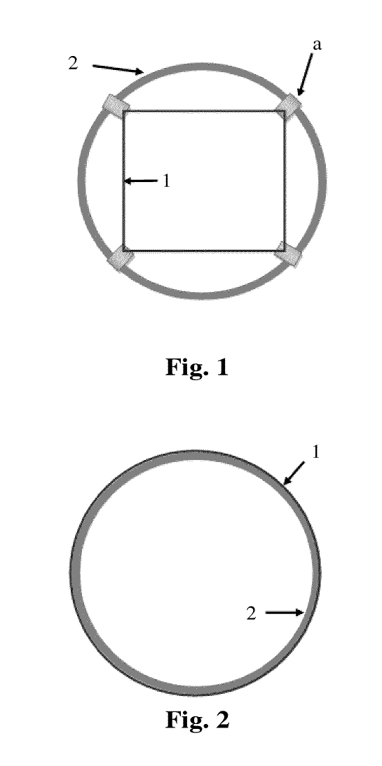

The electrode employed in the invention may be in a closed or open structure in any shape formed of the above wire material, for example the closed polygon ring (such as circle, star or rectangle ring). As shown in FIG. 1, in one specific implementation mode provided in the invention, a square electrode structure is applied, the discharge electrode 1 is partially fixed on an annular support substrate 2 made of an insulating material via a metal connector a, and the other part of the electrode is suspended, to form a square electrode structure as shown. When such structure is applied, the size of the support substrate 2 may be the same as the air duct in the ion generation system, and it also may be smaller than the air duct. FIG. 2 is a structure diagram of another discharge electrode, the discharge electrode 1 is attached onto the outer surface of the insulating support substrate 2, when such structure is employed, the electrode wire may be directly bond on the substrate 2, and it also may be prepared on a flexible printed-circuit board by means of photolithography and then bond on the substrate 2 or directly prepared on the substrate 2 by means of photolithography. In such structure, the size of the substrate 2 should be smaller than the air duct, so that ions emitted by the discharge electrode 1 outside the ring can be lead out effectively.

The ion generation system provided in the invention further includes a fan that is configured to lead (blow) the generated ions out from the ion generation system.

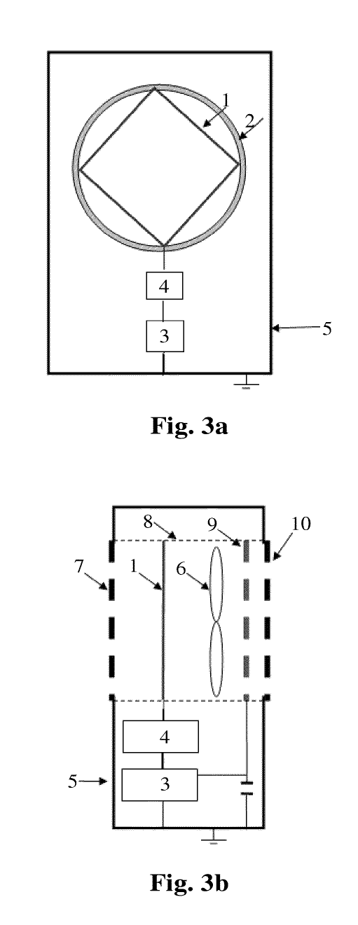

FIG. 3a shows an ion generation system applying the electrode structure as shown in FIG. 1, and FIG. 3b is a side sectional-structure diagram of FIG. 3a. It can be seen from FIG. 3a and FIG. 3b that, a discharge electrode 1 is fixed on the substrate 2 to form a square closed electrode. A controller 3 is electrically connected with a high voltage pulse generator 4, the high voltage pulse generator 4 supplies a voltage to the discharge electrode 1 and a shell 5 is grounded and provided with an air inlet 7 and an air outlet 10. The air inlet 7 and the air outlet 10 shown in FIG. 3b are respectively arranged on two opposite side faces of a shell 5, it should be understood that the arrangement of the air inlet 7 and the air outlet 10 is not limited thereto. Both the air inlet 7 and the air outlet 10 are provided with grounded metal nets, the function of the metal nets is to prevent external objects from entering in the shell, shields the influence on the whole ion generation system from the external electromagnetic fields, and shields electromagnetic interference to the environment from the ion generation system, simultaneously, serves as a ground electrode for the high voltage discharge electrode 1 too. An air duct 8 made of an insulating material is arranged between the air inlet 7 and the air outlet 10, the high voltage discharge electrode 1, a fan 6 and a ion balance detector 9 are arranged in an air duct 8, the discharge electrode 1 is located between the fan 6 and the air inlet 7, the ion balance detector 9 is arranged between the fan 6 and the air outlet 10 and also may be arranged between the discharge electrode 1 and the fan 6. The distance among the discharge electrode 1, the grounded metal net at the air inlet 7 and the ion balance detector 9 is the discharge electrode space, this distance must be set to be more than one centimeter in order to avoid spark discharge. When a power input port supplies a voltage to the control 3, an appropriate pulse high voltage will be applied on the discharge electrode 1 to ionize air into positive/negative ions, these ions are fan out from the system by wind generated by the fan 6 and conveyed to the working area.

It also can be seen from FIG. 3b that, the ion balance detector 9 is arranged between the fan 6 and the air outlet 10, the electromagnetic interference in the environment is shield by the whole shell 5 and the grounded metal nets, the signal (voltage) of the ion balance detector 9 is determined only by the balance status of ions, so that the interference robustness of the ion generation system is improved.

FIG. 4 shows another ion generation system in the invention, this system further includes a DC biasing device 11, and the DC biasing device 11 is electrically connected with the controller 3 and the high voltage pulse generator 4.

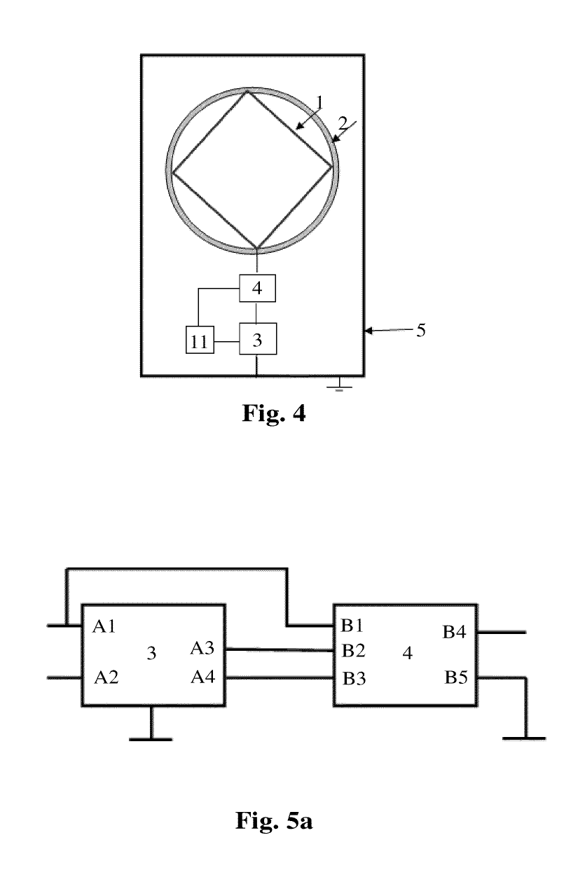

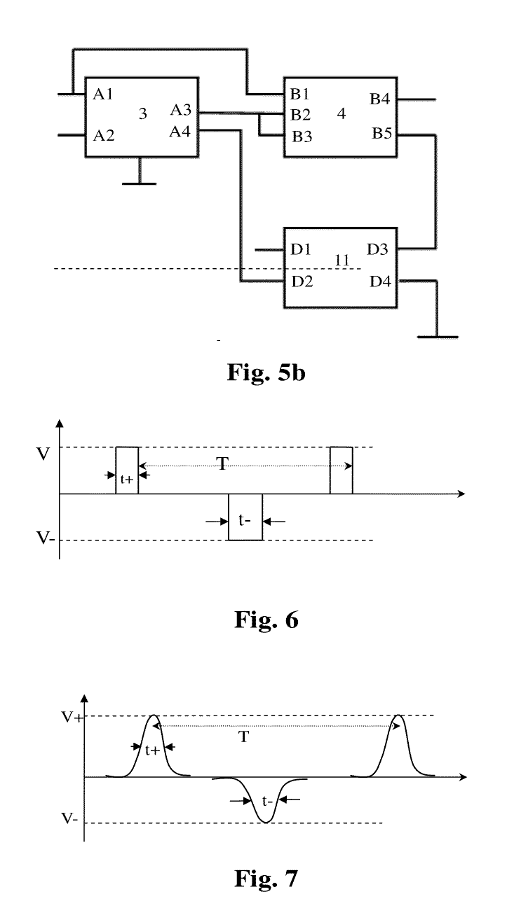

FIG. 5a shows a method about how to regulate the positive/negative pulse height or pulse width of high voltage output. Wherein, the controller 3 includes ports A1-A4, port A1 is a power input port, port A2 receives a signal from the ion balance detector 9, ports A3 and A4 output a control signal and are respectively connected with ports B2 and B3 of the high voltage pulse generator 4, port B1 is a power input port, ports B4 and B5 are high voltage output ports, port B4 is connected with the discharge electrode 1, and port B5 is grounded. The frequency of the pulse high voltage depends on the frequency of the control signal output by the ports A3 and A4 of the controller 3, the positive/negative peak value or pulse width output by port B4 respectively depends on the control signal output by the ports A3 and A4, while the control signal output by the ports A3 and A4 is controlled by the signal from the ion balance detector 9 via port A2. FIG. 5b shows another control mode: biasing control mode, wherein the port A1 of the controller 3 is a power input port, port A2 receives a detection signal from the ion balance detector 9, port A3 is connected with ports B2 and B3 of the high voltage pulse generator 4, port B1 is a power input port, ports B4 and B5 are high voltage output ports, port B4 is connected with the discharge electrode 1, port B5 is connected with the DC biasing output port D3 of the DC biasing device 11, port D1 is the power input port of the DC biasing device 11, port D2 is connected with the control signal output port A4 of the controller, and the other output port D4 of the DC biasing device 11 is grounded. The frequency, positive/negative pulse height and pulse width of the pulse high voltage depend on the control signal output by the output port A3 of the controller, the DC biasing output by the output port D3 of the DC biasing device 11 depends on the control signal from the output port A4 of the controller 3, while-the control signal output by the port A3 is controlled by the signal sent by the ion balance detector 9 via port A2.

The controller 3 receives an ion balance signal transmitted by the ion balance detector 9, controls the output voltage of the high voltage pulse generator 4, and regulates the positive/negative pulse peak value or the pulse width, in order to regulate the yield of positive/negative ions and produce balanced ions output.

In the invention, by providing a pulse high voltage and by compensating and regulating the positive/negative pulse height or pulse width, the yield of positive/negative ions is controlled, and the purpose of balancing the output of positive/negative ions is achieved. The pulse high voltage provided in the invention may be: DC pulse, positive/negative single-pulse, equal-amplitude AC pulse or damped-amplitude AC pulse, or other pulse high voltage modes.

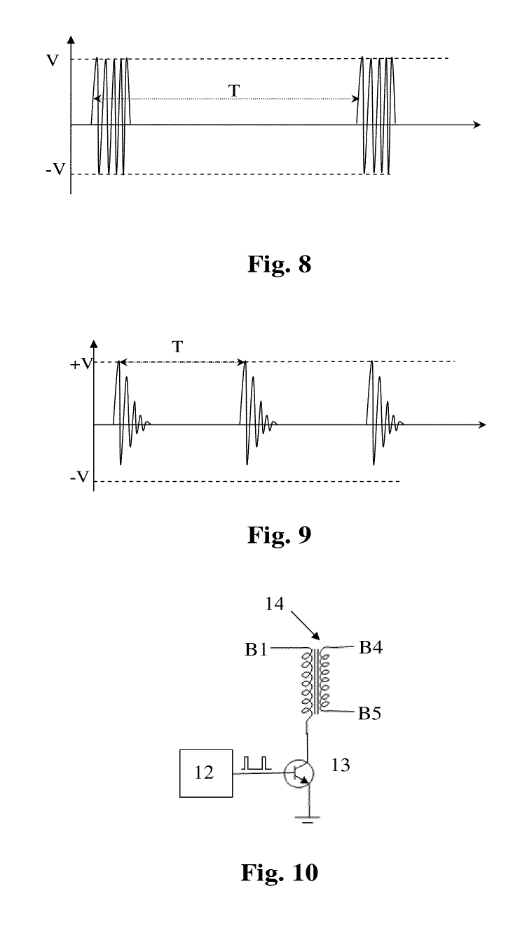

FIG. 6 and FIG. 7 show a high voltage output waveform in DC pulse and positive/negative single-pulse modes, for these two pulse modes, the balanced output of ions can be achieved by the control mode shown in FIG. 5a, that is, by the way of controlling the pulse height or pulse width of positive/negative pulses. First, pulse height, pulse width and pulse period are set to obtain the desired concentration of ions and limited concentration of ozone. The larger the pulse height, the longer the pulse width and the shorter the pulse period, the larger concentration of ions and larger concentration of ozone will be obtained. The frequency and the pulse height and pulse width of the positive (or negative) pulse are fixed based on detected results, that is, the output signal of A3 (or A4) is fixed, while the negative (or positive) pulse height or pulse width is automatically regulated according to the output signal of A4 (or A3) which is based on the input signal of A2, that is, the output signal from the ion balance detector 9, to obtain a balanced ions. For example, when the concentration of negative ions generated in the ion generation system is larger, the metal nets in the ion balance detector 9 will induce a decreased voltage signal (negative voltage increased). Port A2 of the controller 3 will acquire this signal, this signal is output to port B3 of the high voltage pulse generator 4 via port A4, the peak value or pulse width of the negative pulse output by port B4 is reduced, so that the number of the output negative ions is reduced, this signal also may be output to port B2 via port A3, the peak value or pulse width of the positive pulse output from port B4 is increased, so that the number of the output positive ions is increased, so that the balance of positive/negative ions in the system is automatically regulated by feedback control, therefore balanced output of ions is achieved. For the high voltage pulse waveforms shown in FIG. 6 and FIG. 7, balanced output of ions also can be achieved by the control mode shown in FIG. 5b, namely, DC biasing control mode. First, pulse height, pulse width and pulse frequency are determined by using the above test method, that is, the output signal of A3 is fixed, the output signal of A4 is controlled according to the input signal of port A2, namely, output signal of the ion balance detector 9, the DC biasing output by port D3 of the DC biasing device 11 is regulated, so that the pulse height of positive/negative pulse of the pulse high voltage output by the pulse high voltage output port B4 is regulated, and regulation and control for the yield of positive/negative ions are completed. For example, when the concentration of negative ions in the ion generation system is higher, the metal nets in the ion balance detector 9 will induce a decreased voltage signal (negative voltage increased) according to the positive or negative concentration of the ion wind, port A2 of the controller 3 will acquire this signal, this signal is output to port D2 of the bias device 11 via port A4, the DC biasing voltage output by the port D3 is increased (that is, the positive biasing is increased or the negative biasing is reduced), the biasing is overlapped to the pulse high voltage output by the high voltage pulse generator 4, so that the positive pulse peak value of the pulse voltage output by port B4 is increased while the negative pulse peak value is reduced simultaneously, as a result, positive ions are increased while negative ions are reduced simultaneously, so that the balance of positive/negative ions in the system is automatically regulated by feedback control, therefore balanced output of ions is achieved.

FIG. 8 shows an output waveform of an equal-amplitude AC pulse high voltage, For this waveform, the balanced output of ions can only be achieved by the control mode shown in FIG. 5b, namely, DC biasing control mode. First, pulse amplitude, oscillation frequency of single pulse, pulse width and pulse period are set to obtain the desired concentration of ions and limited concentration of ozone, the larger the pulse amplitude, the higher the oscillation frequency, the longer the pulse width and the shorter the pulse period, the larger the concentration of the output ions and the larger the concentration of ozone. Pulse amplitude, oscillation frequency, pulse width and pulse period are fixed then, that is, the output signal of A3 in FIG. 5b is fixed, the output signal of A4 is controlled according to the input signal of port A2, namely, the output signal of the ion balance detector 9, the DC biasing output by port D3 of the biasing device 11 is regulated, so that the positive/negative pulse peak value of the I-pulse high voltage output by the output port B4 of the high voltage pulse generator 4 is regulated, and the control of the yield of positive/negative ions is completed.

FIG. 9 shows a damped-amplitude AC pulse waveform, the pulse height means the maximum peak value of single damped-amplitude AC pulse, the pulse is defined as a positive pulse when the maximum peak value is positive, and the pulse is defined as a negative pulse when the maximum peak value is negative. For this waveform, as the oscillation frequency and pulse width thereof are determined by the pulse high voltage generator, the balanced output of ions can be achieved by controlling the pulse height of positive/negative pulse by the way shown in FIG. 5a. First, pulse height and pulse period are set to obtain the desired concentration of ions and limited concentration of ozone, the larger the pulse height and the shorter the pulse period, the larger the concentration of the output ions and the larger the concentration of ozone. Pulse period and pulse height of the positive (or negative) pulse are fixed then, that is, the output signal of A3 (or A4) is fixed, for the output signal of A4 (or A3), the negative (or positive) pulse height is automatically regulated according to the input signal of A2, namely, the output signal from the ion balance detector 9, to obtain a balanced ions. For this waveform, the balanced output of ions also may be achieved by the control mode shown in FIG. 5b, namely, DC biasing control mode. First, pulse height and pulse period are determined by using the above method, that is, the output signal of A3 in FIG. 5b is fixed, the output signal of A4 is controlled according to the input signal of port A2, namely, the output signal from the ion balance detector 9, the DC biasing output by port D3 of the biasing device 11, so that the pulse height of positive/negative pulse of the pulse high voltage output by the output port B4 of the high voltage pulse generator 4 is regulated, and the control of the yield of positive/negative ions is completed.

FIG. 10 is a circuit diagram of a high voltage pulse generator in the invention. 14 is a high voltage transformer, B1 is a power input port, B4 is a high voltage output port, and port B5 is connected with the output port D3 of the biasing device 11; a oscillation circuit 12 can generate a pulse signal with a certain pulse width and pulse period, this pulse signal acts on a switching transistor 13, so that the switching transistor 13 produces ON and OFF actions, in order to output a high voltage pulse waveform as shown in FIG. 9.

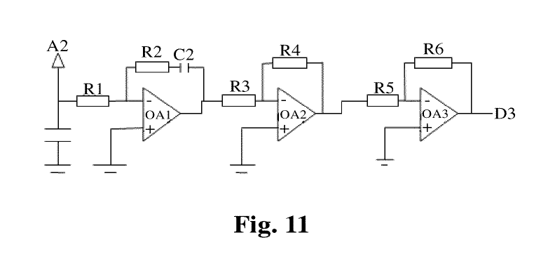

FIG. 11 is a circuit diagram of controller 3 and biasing device 11. Port A2 is connected with the ion balance detector 9, R1, R2, C2 and operational amplifier OA1 form an proportional integral circuit. When ions are unbalanced, an induced signal voltage on capacitor C1 will be induced by balance detector 9, the signal voltage is integrated by the proportional integral circuit to provide an inverting voltage output. Operational amplifiers OA2 and OA3 and R3, R4, R5 and R6 form two stages of inverting amplification, and the biasing is applied to the high voltage pulse generator 4 via port D3. For example, when-positive ions is higher, a positive voltage will be established on capacitor C1, this voltage is integrated by the proportional integral-circuit to provide a negative voltage output, after the two stages of inverting amplification. A certain level of negative biasing will be output by the port D3 to the-high voltage transformer to decrease the positive voltage peak value and increase the negative voltage peak value on the electrode, and correspondingly the yield of positive ions will be decreased and the yield of negative ions will be increased, thus, the balanced output of ions will be obtained.

In conclusion, by the ion generation system and the method for controlling the ion balance in the invention, an ion generation system that can regulate the ion balance automatically is achieved. By the real-time monitoring the ion balance status, the controller sends control signals timely and continuously, real-time regulation of high voltage pulse is achieved, and so that the balanced ions is guaranteed. Compared with needle electrodes, the discharge area extends to the whole electrode wire, the damage of the electrode is reduced, and the maintenance cost is reduced. By optimizing peak value, pulse width and pulse period of the pulse high voltage, the generation of ozone is reduced effectively.

During the industrial production, such ion generation system may be applied in various production fields, such as printing, spinning, copying and production field of plastic films, particularly, may be applied in electrostatic damage protection in the manufacturing process of microelectronic devices such as highly integrated LC, LED, LCD and computer hard disk head.

Above contents are only preferred embodiments of the disclosure and are not used for limiting the disclosure. For persons skilled in the field, the disclosure may have various alternations and changes. Any modifications, equivalent replacements and improvements made within the spirit and principle of the disclosure should be contained within the protection scope of the disclosure.

1. An ion generation system, including a high voltage pulse generator, wherein the ion generation system further includes:
an ion balance detector, configured to induce an ion balance signal; and
a controller, connected between the ion balance detector and the high voltage pulse generator, and configured to output a control signal according to the ion balance signal in order to control an output pulse of the high voltage pulse generator.

2. The ion generation system according to claim 1, wherein the ion generation system further includes a DC biasing device, which is electrically connected with the controller and the high voltage pulse generator and configured to regulate a peak difference between positive peak and negative peak of an output pulse high voltage.

3. The ion generation system according to claim 1, wherein the ion generation system further includes a shell, which is grounded and provided with an air inlet and an air outlet.

4. The ion generation system according to claim 3, wherein grounded metal nets are arranged at the air inlet and the air outlet.

5. The ion generation system according to claim 3, wherein the ion balance detector is a metal net-like ion balance detector located inside the shell.

6. The ion generation system according to claim 3, wherein the ion generation system further includes a fan.

7. The ion generation system according to claim 3, wherein the ion generation system further includes a discharge electrode that is a closed or open form of electrode formed of metal filaments.

8. The ion generation system according to claim 7, wherein the discharge electrode is attached onto an annular insulating substrate to form a round or any other shape, or partially fixed on the insulating substrate via a metal connector to form any polygon.

9. The ion generation system according to claim 7, wherein the diameter of the discharge electrode ranges from one micrometer to ten millimeters.

10. The ion generation system according to claim 1, wherein the high voltage pulse generator includes a high voltage transformer, an oscillation circuit and a switching transistor; the oscillation circuit is connected with the base of the switching transistor, the high voltage transformer is connected with the collector of the switching transistor, the oscillation circuit generates a pulse signal including a pulse width and a pulse period according to a signal sent by the controller and acts on the switching transistor.

11. The ion generation system according to claim 2, wherein the controller includes a proportional integral circuit, and the DC biasing device includes two stages of inverting amplifiers.

12. A method for controlling the ion balance, wherein the method comprises:
the ion balance is detected;
a controller sends a control signal according to the ion balance status;
a high voltage pulse generator regulates an output pulse according to the control signal.

13. The method according to claim 12, wherein a DC biasing device receives the control signal and generates a DC biasing, to regulate a peak difference of a positive peak and a negative peak of an output pulse.

14. The ion generation system according to claim 2, wherein the ion generation system further includes a shell, which is grounded and provided with an air inlet and an air outlet.
